(19) United States
(12) Patent Application Publication
(10) Pub. No.: US 2011/0320836 A1
(43) Pub. Date: Dec. 29, 2011

(54) Apparatus and Method of Managing Consumption in the Apparatus

(75) Inventors: Adam Johnston, Cambridge (GB); Carlos Garcia-Tobin, Cambridge (GB)

(73) Assignee: NOKIA CORPORATION, Espoo (FI)

(21) Appl. No.: 13/130,355

(22) PCT Filed: Nov. 18, 2009
(86) PCT No.: PCT/IB2009/055144

§ 371 Date: Sep. 6, 2011

(30) Foreign Application Priority Data
Nov. 21, 2008 (GB) 0821362.1

(51) Int. Cl. G06F 1/32

(52) U.S. Cl. 713/320

(57) ABSTRACT

An apparatus (10) comprising an event monitor (20) for observing events occurring within the computing device (10) and a prediction component (22), wherein the prediction component (22) is configured to cause an operating parameter associated with the power consumption of the computing device (10) to change if a sequence of events observed by the event monitor (20) corresponds to a pre-defined sequence associated with the change in the operating parameter.

### TECHNICAL FIELD

The present invention relates to an apparatus such as, for example, a computing device, and to a method of managing power consumption in such an apparatus

### BACKGROUND TO THE INVENTION

Power consumption has long been a concern for designers, manufacturers and users of computing devices, and as portable computing devices such as mobile telephones have become more prevalent this issue has taken on an increasingly important role, as designers and manufacturers endeavour to meet user expectations of the battery life of such devices.

### SUMMARY OF INVENTION

Various aspects of the invention are set out in the appended claims.

According to a first aspect of the invention, there is provided an apparatus, comprising: an event monitor for observing events occurring within the apparatus, and a prediction component, wherein the prediction component is configured to cause an operating parameter associated with the power consumption of the apparatus to change if a sequence of events observed by the event monitor corresponds to a pre-defined sequence associated with the change in the operating parameter.

According to a second aspect of the invention, there is provided an apparatus, comprising: at least one processor; and at least one memory including computer program code, the at least one memory and the computer program code configured to, with the at least one processor, cause the apparatus to perform at least the following: manage power consumption in the apparatus, by: observing events occurring in the apparatus and changing an operating parameter of the apparatus associated with the power consumption of the apparatus if an observed sequence of events corresponds to a pre-defined sequence of events associated with the change in the operating parameter.

According to a third aspect of the invention, there is provided a method, comprising: managing power consumption in an apparatus, including: observing events occurring in the apparatus and changing an operating parameter of the apparatus associated with the power consumption of the apparatus if an observed sequence of events corresponds to a pre-defined sequence of events associated with the change in the operating parameter.

### BRIEF DESCRIPTION OF THE DRAWINGS

For a more complete understanding of example embodiments of the present invention, reference is now made to the following descriptions taken in connection with the accompanying drawings in which:

FIG. 1 is a schematic illustration showing selected elements of a mobile telephone in accordance with a second example embodiment of the present invention;

FIG. 2 is a block flow diagram illustrating the operation of a load monitor in the second example embodiment;

FIG. 3 is a block flow diagram illustrating the operation of a learning component in the second example embodiment;

FIG. 4 is a block flow diagram illustrating the operation of a prediction component in the second example embodiment; and

FIG. 5 is a block diagram illustrating a computer readable medium having code modules stored thereon to implement the components of the second example embodiment.

### DESCRIPTION OF THE EMBODIMENTS

In order to reduce power consumption in a computing device systems have been developed in which the operating frequency of a processor of a computing device is varied according to the demand on the processor. A lower operating frequency requires a lower supply voltage to the processor and thus the power consumption of the device can be reduced by reducing the operating frequency of the device when the demand on the processor drops.

Such systems typically adopt one of two approaches. In the first approach, applications used by the computing device register their performance requirements, such that the device can determine the overall performance requirements and adjust the operating frequency of the processor accordingly. In this approach applications are designed or adapted to comply with the particular performance requirement reporting system used by the device, which adds to the complexity of the applications. Moreover, different devices may have different performance requirement reporting systems, meaning that different versions of the same application must be produced for compatibility with the different devices.

The second approach is to monitor the load on the processor of the device, and to adjust the operating frequency of the processor to its lowest possible value, without overloading it, in response to a change in the demand placed on the processor. In this approach the adjustment to the operating frequency of the processor lags behind the change in the load on the processor that caused the adjustment. Thus, when the load on the processor increases, the processor is overloaded until the increase in its operating frequency is effected, resulting in a temporary loss of performance. If the load on the processor decreases, the processor will run at a higher frequency than is necessary until the change in operating frequency is effected, resulting in a temporary waste of energy.

A first example embodiment of the invention takes a different approach from the above, and in particular is directed at monitoring sequences of events in a computing device, and changing an operating parameter of the computing device if a monitored sequence of events corresponds to a pre-determined sequence of events taken from a set of such predetermined sequences, the pre-determined sequences of events having operating parameter changes respectively associated therewith. Thus, for example, a particular sequence of events that may occur may have associated therewith an operating parameter change in the form of an increase in processor speed. In this example, when the particular sequence of events is monitored, the operating parameter change in the form of the increase in processor speed is implemented. In this way, in this example the required desirable operating parameters of the computing device can be predicted and the operating parameters adjusted thereto based on monitored sequences of events.

Within the first example embodiment a computing device is provided comprising an event monitor for observing events occurring within the computing device. A prediction component is also provided in this example within the computing device, the prediction component being configured to cause an operating parameter associated with the power consumption of the computing device to change if a sequence of events observed by the event monitor corresponds to a pre-defined sequence. In particular, in this example, the pre-defined sequence is associated with the change in the operating parameter that occurs.

In this first example embodiment the prediction component of the present invention is able to predict, based on the events observed by the event monitor, when the operating parameters of the computing device will need to change to meet changing power requirements. For example, the operating parameter associated with the power consumption of the device can then be changed in a timely fashion to ensure that any loss of performance as a result of the change is minimised, whilst also minimising unnecessary power consumption.

In the first example embodiment the computing device may further comprise a learning component which is configured to learn the pre-defined sequence of events associated with the change in the operating parameter. For example, the learning component may be associated with the event monitor and may be configured to make a prediction relating to the operating parameter if a sequence of events observed by the event monitor corresponds to a sequence previously recorded by the learning component.

In the first example embodiment the computing device may further comprise a processor load monitor, and the learning component may for example be configured to verify its prediction by examining the processor load monitor after the sequence of events recorded by the learning component has occurred. For example, the recorded sequence of events may be associated with a score, which score is changed if the prediction was correct.

In the first example embodiment the prediction component may be configured to store the recorded sequence of events as a pre-defined sequence if the score reaches a predetermined threshold. Thus, for example, over time the learning component is able to learn which sequences of events are likely to give rise to changes in the operating parameter associated with the power consumption of the device, and the prediction component is able to store these sequences of events, and the associated changes in the operating parameter, for future use, to reduce the power consumption by pre-emptively changing the operating parameter in response to the sequences of events.

In the first example embodiment the learning component may be configured to record a sequence of events observed by the event monitor if the observed sequence of events does not correspond to a sequence previously recorded by the learning component. For example, new sequences of events which may give rise to a change in the operating parameter of the device can be learned.

In the first example embodiment the operating parameter may comprise an operating frequency of a processor of the computing device. That is, for example, the operating frequency may be changed so as to be higher, for example when the processing load on the device is predicted, via the monitored sequence of events, to be larger, or may be changed so as to be lower, for example when the processing load on the device is predicted, via the monitored sequence of events, to be smaller.

In one example of the first example embodiment the computing device may be a symmetric multi-processor device and the operating parameter may comprise the number of processors that are enabled.

Alternatively, in another example of the first example embodiment the computing device may be a heterogeneous multi-processor device and the operating parameter may comprise the type of processors that are enabled.

In one example of the first example embodiment the computing device is a mobile telephone. In other examples of the first example embodiment the computing device may be any other computing device such as a desktop computer, laptop computer, personal digital assistant (PDA), MP3 player, portable video player, digital camera, and the like.

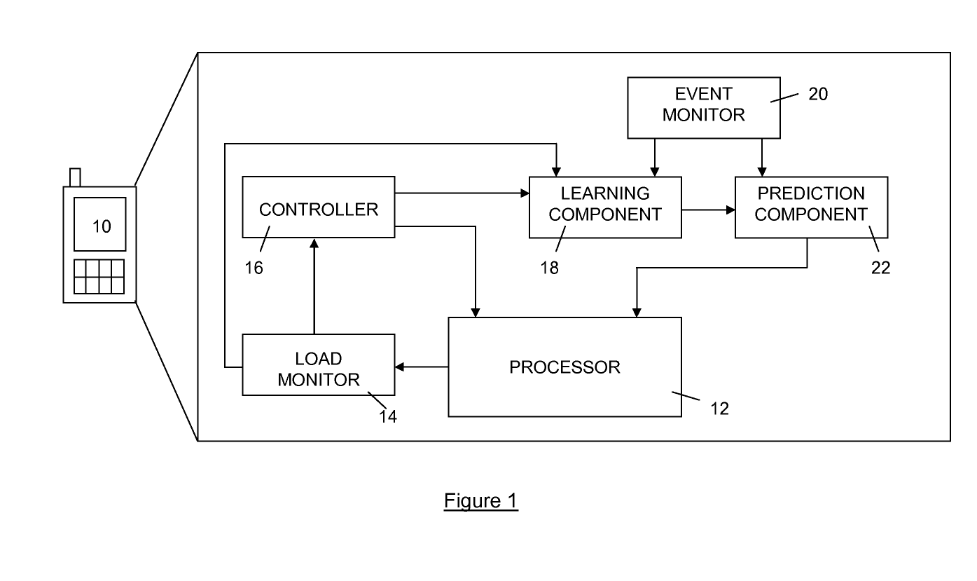

A second example embodiment of the present invention will now be described with respect to FIGS. 1 to 5.

Referring to FIG. 1, a portable computing device, in this example a mobile telephone, is shown generally at 10. For the sake of clarity and brevity only those elements of the mobile telephone 10 which are directly relevant to the present example embodiment are illustrated in FIG. 1, but it will be appreciated that the mobile telephone 10 comprises additional elements and components. Moreover, it is to be understood that the mobile telephone 10 illustrated in FIG. 1 is only one example of a computing device in which examples of the present invention can be implemented, and that examples of the present invention are equally applicable to other computing devices such as desktop computers, laptop computers, personal digital assistants (PDAs) and the like.

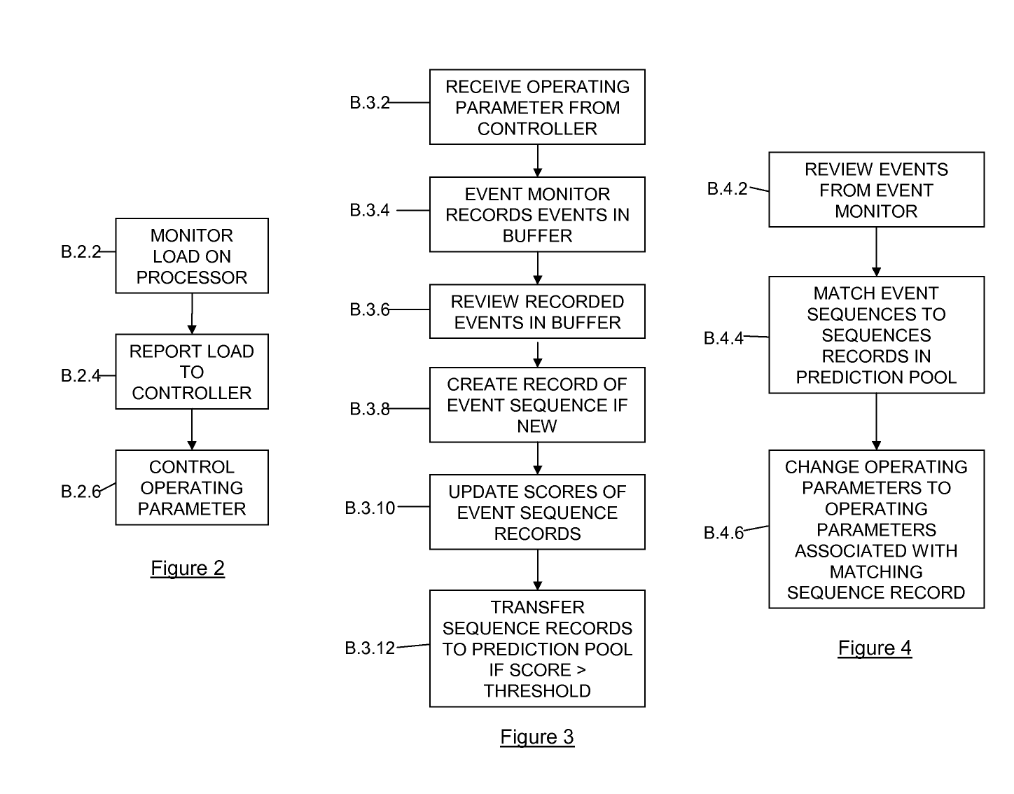

In this example the mobile telephone 10 comprises one or more processors 12 for handling application software which runs on the device, such as, for example, a media player, web browser, organiser, games and the like, as well as an operating system of the mobile telephone 10. In this example, and with further reference to FIGS. 2 to 4, a processor load monitor 14 is provided to monitor the load on the processor(s) 12 (B.2.2). The processor load monitor 14 in this example reports the load on the processor(s) 12 to a controller 16 (B.2.4) which in this example is configured to control an operating parameter of the mobile telephone 10 (B.2.6) which affects the power consumption of the mobile telephone 10. For example, the controller 16 may control the operating frequency of the processor 12 in a single-processor device, or may in another example control the number of processors 12 that are enabled in a symmetric multi-processor device, or may in a further example control the type of processors 12 that are enabled in a heterogeneous multi-processor device.

In the second example embodiment, the controller 16 also reports the operating parameters of the mobile telephone 10, such as the operating frequency of the processor(s) 12 or the number or type of processor(s) which have been enabled, to a learning component 18, as shown at B.3.2 of FIG. 3. In this example the learning component 18 is connected to an event monitor 20 which monitors events occurring in the mobile telephone 10.

In this example an operation or activity which will cause a change in the demand on the processor(s) 12 of the mobile telephone 10 is typically preceded by one or more events, and the event monitor 20 is configured to keep a record of such events in a suitable buffer (B.3.4), which must be large enough to accommodate records of a large number of such events.

For example, when a media file such as an MP3 file is played using a media player application of the mobile telephone 10, the media player application is run and a handle to the media file is opened. These events can for example be detected by monitoring a program loader (i.e. a software component responsible for loading applications or drivers into memory of the mobile telephone 10 and preparing them to run), a file server (i.e. a software component which is responsible for accessing files stored in a file system) and a scheduler of the mobile telephone 10.

Typically, prior to playing the media file, in one example the following sequence of events will take place in the mobile telephone 10:
A handle to the media file is opened by the file server;
The file type is recognised by a multimedia sub-system of the mobile telephone 10;
The media player application is loaded by the program loader or a file server;
A media player thread is scheduled by a scheduler of the mobile telephone 10;
A sound driver is loaded by the program loader or file server;
A suitable codec (e.g. an MP3 codec) is loaded by the program loader or file server;
The codec is scheduled by the scheduler;
The multimedia sub-system sends audio data to the sound driver.

As another example, prior to commencing a video call a camera of the mobile telephone 10 is launched and a telephony stack of the mobile telephone 10 is started, by loading appropriate drivers and scheduling appropriate threads. These events can be detected for example by monitoring the program loader, scheduler and telephony stack. Similarly, if a Java® game is launched on the mobile telephone 10 this will typically be preceded by a large increase in the amount of memory allocated to a Java Virtual Machine (JVM) of the mobile telephone 10, for example, which can be detected by monitoring a kernel or user allocator of the mobile telephone 10.

In the second example embodiment the event monitor 20 is configured to monitor the file server, the program loader, the scheduler, the kernel or user allocator, the telephony stack and other subsystems and software components of the mobile telephone 10, as well as user events occurring in the mobile telephone 10, and to record events which occur in these subsystems and software components in the buffer (B.3.4).

In the second example embodiment the learning component 18 is configured to determine whether a particular sequence of events recorded by the event monitor 20 is likely to lead to a change in the load on the processor(s) 12. In this example every time the controller 16 changes the operating frequency of the processor(s) 12 or another operating parameter of the mobile telephone 10 such as, for example, the number or type of processors 12 that are enabled in response to a change in the demand on the processor(s) 12, the learning component 18 examines the contents of the buffer of the event monitor 20 (B.3.6) and creates a record of the change in the operating parameters and the events that preceded the change (B.3.8). In this way in this example the learning component 18 builds up a list (or “learning pool”) of event sequences which may cause a change in one or more operating parameters of the mobile telephone 10. In this example the newly-created record is also allocated a score of zero, which for example changes depending upon the accuracy of predictions made by the learning component 18 of whether an operating parameter of the mobile telephone 10 will change as a result of the recorded sequence of events, as will be described below.

In the second example embodiment the learning component 18 continually monitors the event monitor 20 such that any time a sequence of events occurs which corresponds to a sequence which is already stored in a record in the learning component 18, the learning component 18 is able to predict whether that sequence will cause a change in one or more operating parameters of the mobile telephone 10. In this example the learning component 18 then checks whether its prediction was correct by examining the processor load monitor 14 after the sequence of events. In this example if the prediction of the learning component 18 was correct, the score associated with that particular sequence of events and the associated change in operating parameters is incremented, whereas if the prediction of the learning component 18 was incorrect, the score associated with the sequence of events and the associated change in operating parameters is decremented (B.3.10).

For example, the event sequence {A, B, C} may be recorded in the learning component 18 and associated with the action “Reduce Operating Frequency of Processor”. If the learning component 18 recognises this event sequence in the buffer of the event monitor 20, and the operating frequency of the processor 12 is subsequently reduced, the score associated with the sequence and the change in the operating parameter (i.e. the reduction in the operating frequency of the processor 12) is incremented. However, if following the event sequence {A, B, C} the operating frequency of the processor does not change, the score is decremented.

In this example the learning component 18 uses a pattern matching algorithm to recognise event sequences stored in the buffer of the event monitor 20. Thus, for example, the sequence {A, B, X, Y, C, D, Z, E} appearing in the buffer would be recognised as both sequences {A, B, C} and {X, Y, Z} by the learning component 18.

In the second example embodiment once the score associated with a particular sequence of events reaches a predetermined threshold, that sequence of events, and the associated change in the operating parameter(s) of the mobile telephone 10, are added to a list (or “prediction pool”) stored in a prediction component 22 which is connected to the learning component 18 (B.3.12). On the other hand, if, for example, the score associated with a particular sequence in the learning pool drops to a predetermined negative threshold value that sequence is removed from the learning pool. Of course, it will be appreciated that in one example the positive and negative thresholds in the example given above could be reversed such that the score associated with a particular event sequence is decremented if the prediction made by the learning component 18 is correct, with the event sequence and associated change in the operating parameter(s) of the mobile telephone 10 being added to the predicting pool if the score reaches a predetermined negative threshold.

In the second example embodiment the prediction component 22 continually monitors the event monitor 20 (B.4.2), such that if a sequence of events recorded by the event monitor 20 matches a sequence in the prediction pool (B.4.4) the prediction component 22 is able to make the associated change to the operating parameters of the mobile telephone 10 without the intervention of the controller 16. In this way, in this example the prediction component 22 is able to recognise sequences of events that will necessitate a change to one or more operating parameters of the mobile telephone 10 and make the necessary change pre-emptively (B.4.6), thus reducing the power consumption of the mobile telephone 10.

Within the second example embodiment, eventually when the prediction pool contains all possible sequences of events and their associated changes to the operating parameters of the mobile telephone 10 the controller 16 will become redundant, as it will not be required to implement changes to the operating parameters of the mobile telephone 10. Of course, if new functionality is added to the mobile telephone 10, for example if its operating system is upgraded, the controller 16 will need to be used to change the operating parameters until such time as the learning component 18 has successfully learned all of the new event sequences and their associated changes to the operating parameters and stored them in the prediction pool.

In the second example embodiment when every possible sequence of events and its associated change in the operating parameters of the mobile telephone has been successfully recorded in the prediction pool, the contents of the prediction pool may for example be extracted and saved as a file which can be used to pre-load the prediction pool of newly-manufactured mobile telephones 10. In this way, for example, there is no need for each new mobile telephone 10 to undergo a period of training but instead the new mobile telephones 10 will be able to benefit immediately from the pre-loaded prediction pool to reduce power consumption.

It will be appreciated by those skilled in the relevant art that within the second example embodiment the processor load monitor 14, the controller 16, the learning component 18, the event monitor 20 and the prediction component 22 may for example be implemented as individual hardware elements, such as individual integrated circuits, or may be implemented for example as component parts of a device such as an FPGA, or may be implemented for example as software components running on a suitably-configured processor, or as a combination of these different implementations.

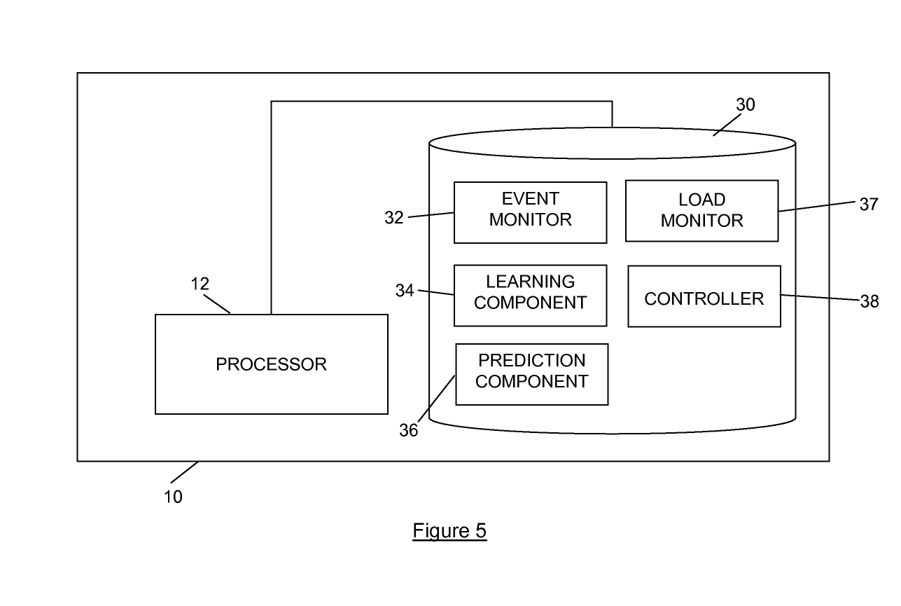

In one particular example, the second example embodiments is implemented as software modules stored on a computer readable medium, as shown in FIG. 5. Here, in this example the computing device 10 has a processor 12 and a computer readable medium 30, which stores software modules relating to the various components of the second example embodiment already described. Hence, an event monitor module 32 is provided, as well as a load monitor module 37, and a controller module 38. In addition, a learning component module 34 and a prediction component module 36 is also provided. The various software modules when run as processes on the processor 12 operate to provide the functionality described above so as to implement the present example.

In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-11. (canceled)

12. An apparatus, comprising:
at least one processor; and
at least one memory including computer program code the at least one memory and the computer program code configured to, with the at least one processor, cause the apparatus to perform at least the following:
manage power consumption in the apparatus, to at least:
observe events occurring in the apparatus and
change an operating parameter of the apparatus associated with the power consumption of the apparatus if an observed sequence of events corresponds to a pre-defined sequence of events associated with the change in the operating parameter.

13. An apparatus according to claim 12, the at least one memory and the computer program code configured to, with the at least one processor, cause the apparatus to learn the pre-defined sequence of events associated with the change in the operating parameter.

14. An apparatus according to claim 13, wherein learning the pre-defined sequence of events associated with the change in the operating parameter comprises making a prediction relating to the operating parameter if an observed sequence of events corresponds to a sequence previously recorded by the learning component.

15. An apparatus according to claim 14, wherein learning the pre-defined sequence of events associated with the change in the operating parameter further comprises to verify the prediction by examination of a load on the processor of the apparatus after the sequence of events recorded by the learning component has occurred.

16. An apparatus according to claim 15 wherein the recorded sequence of events is associated with a score, which score is changed if the prediction was correct.

17. An apparatus according to claim 16 wherein if the score reaches a predetermined threshold the recorded sequence of events is stored as a pre-defined sequence.

18. An apparatus according to claim 14 wherein if an observed sequence of events recorded does not correspond to a sequence previously recorded by the learning component the learning component records the sequence of events.

19. An apparatus according to claim 12, the at least one memory and the computer program code configured to, with the at least one processor, cause the apparatus to store a plurality of pre-defined sequences of events and associated changes in operating parameter in a prediction pool, compare the observed sequence of events with the pool of pre-defined sequences of events, and select a pre-defined sequence of events that substantially matches the observed sequence of events, the change in operating parameter being that change associated with the substantially matching pre-defined sequence of events from the pool.

20. An apparatus according to claim 12 wherein the apparatus is a computing device, and the operating parameter comprises an operating frequency of the processor.

21. An apparatus according to claim 12 wherein the apparatus is a symmetric multi-processor computing device and the operating parameter comprises the number of processors that are enabled.

22. An apparatus according to claim 12 wherein the apparatus is a heterogeneous multi-processor computing device and the operating parameter comprises the type of processors that are enabled.

23. A method, comprising:
managing power consumption in an apparatus, including:
observing events occurring in the apparatus and
changing an operating parameter of the apparatus associated with the power consumption of the apparatus if an observed sequence of events corresponds to a pre-defined sequence of events associated with the change in the operating parameter.

24. A method according to claim 23 further comprising learning the pre-defined sequence of events associated with the change in the operating parameter in a learning component of the apparatus.

25. A method according to claim 24 wherein learning the pre-defined sequence of events associated with the change in the operating parameter comprises making a prediction relating to the operating parameter if an observed sequence of events corresponds to a sequence previously recorded by the learning component.

26. A method according to claim 25 wherein learning the pre-defined sequence of events associated with the change in the operating parameter further comprises verifying the prediction by examining a load on a processor of the apparatus after the sequence of events recorded by the learning component has occurred.

27-28. (canceled)

29. A method according to claim 25 wherein if an observed sequence of events recorded does not correspond to a sequence previously recorded by the learning component the learning component records the sequence of events.

30. A method according to claim 23, and further comprising storing a plurality of pre-defined sequences of events and associated changes in operating parameter in a prediction pool, comparing the observed sequence of events with the pool of pre-defined sequences of events, and selecting a pre-defined sequence of events that substantially matches the observed sequence of events, the change in operating parameter being that change associated with the substantially matching pre-defined sequence of events from the pool.

31. A method according to claim 12 wherein the apparatus is a computing device, and the operating parameter comprises an operating frequency of a processor of the device.

32. A method according to claim 12 wherein the apparatus is a symmetric multi-processor computing device and the operating parameter comprises the number of processors that are enabled.

33-34. (canceled)

35. A computer readable medium storing a computer program so arranged such that when executed by a computer it causes the computer to operate in accordance with the method of claim 23.
